(19) United States
(12) Patent Application Publication
(10) Pub. No.: US 2019/0384449 A1
(43) Pub. Date: Dec. 19, 2019

(54) METHOD AND APPARATUS FOR LIMITING A SENSING REGION OF A CAPACITIVE SENSING ELECTRODE

(71) Applicant: NOKIA TECHNOLOGIES OY, Espoo (FI)

(72) Inventors: Yu WANG, Beijing (CN); Jiafei CHEN, Beijing (CN)

(73) Assignee: NOKIA TECHNOLOGIES OY, Espoo (FI)

(21) Appl. No.: 16/557,064

(22) Filed: Aug. 30, 2019

Related U.S. Application Data
(63) Continuation of application No. 14/762,628, filed on Jul. 22, 2015, now abandoned.

(51) Int. Cl. G06F 3/041; G06F 3/044; G06F 1/16

(52) U.S. Cl. CPC G06F 3/0416; G06F 2203/04101; G06F 1/16; G06F 3/044

(57) ABSTRACT

An apparatus includes a dielectric layer and a capacitive sensing electrode proximate a first surface of the dielectric layer. A conductive layer is proximate the first surface of the dielectric layer. The conductive layer at least partially surrounds the capacitive sensing electrode and is coupled to a predetermined electrical potential. The conductive layer limits a sensing region of the capacitive sensing electrode.

### CROSS-REFERENCE TO RELATED APPLICATIONS

This application is a continuation of U.S. application Ser. No. 14/762,628, filed Jul. 22, 2015, which is a national phase entry of International Application No. PCT/CN2013/070884, filed Jan. 23, 2013, the entire contents of which are incorporated herein by reference.

### TECHNICAL FIELD

The present specification relates to electronic sensors.

### BACKGROUND

Mobile devices such as cellular phones often use proximity detectors. For example, a cellular phone may detect a person's face near the phone's touchscreen during a phone conversation. In response, the touchscreen can be disabled so as to prevent inadvertent activation of a phone control (e.g., dialing, hang up, etc.) and/or to conserve power during the call. The touchscreen can be re-enabled when pulled away from the person's face to facilitate hanging up or dialing. A proximity detector may also be used similarly with a cover that protects the touchscreen. In such a configuration, the touchscreen can be automatically disabled and enabled in response to detecting the cover is closed or open.

### SUMMARY

The present specification discloses a method, system, and apparatus that limits a sensing region of a capacitive sensing electrode. In one aspect, an apparatus includes a dielectric layer and a capacitive sensing electrode proximate a first surface of the dielectric layer. A conductive layer is proximate the first surface of the dielectric layer. The conductive layer at least partially surrounds the capacitive sensing electrode and is coupled to a predetermined electrical potential. The conductive layer limits a sensing region of the capacitive sensing electrode.

In another aspect, and apparatus includes a capacitive proximity sensor is proximate an outer surface of the apparatus. The capacitive proximity sensor includes a dielectric proximate the outer surface of the apparatus and an electrode proximate a first surface of the dielectric. A ground plane is proximate a second surface of the dielectric. The ground plane includes a void below the electrode and having a perimeter larger than the electrode. The ground plane limits a sensing region of the electrode.

In another aspect, a method involves applying a bias signal to an electrode of a capacitive proximity sensor. The electrode disposed on surface of a dielectric layer. A constant electrical potential is applied to a conductive layer proximate the surface of the dielectric layer, the conductive layer at least partially surrounding the electrode and limits a sensing region of the electrode. An object's proximity to the capacitive proximity sensor is determined based on a response to the bias signal.

In another aspect, an apparatus includes dielectric means for mounting a capacitive sensing means. Means for limiting a sensing region of the capacitive sensing means is also mounted proximate the dielectric means and at least partially surrounds the capacitive sensing means and is coupled to a predetermined electrical potential.

The above summary is not intended to describe each disclosed embodiment or every implementation. For a better understanding of variations and advantages, reference should be made to the drawings which form a further part hereof, and to accompanying descriptive matter, which illustrate and describe representative embodiments.

### BRIEF DESCRIPTION OF THE DRAWINGS

In the following diagrams, the same reference numbers may be used to identify similar/same components in multiple figures.

FIG. 1 is a perspective view of a mobile apparatus with a capacitive proximity sensor according to an example embodiment;

FIG. 2 is a plan view of a proximity sensor according to an example embodiment;

FIG. 3 is a cross sectional view of a proximity sensor according to an example embodiment;

FIG. 4 is a cross sectional view of a proximity sensor according to another example embodiment;

FIG. 5 is a perspective view of a multi-surface capacitive proximity sensor according to an example embodiment;

FIG. 6 is a block diagram of a circuit arrangement using a capacitive proximity sensor according to an example embodiment;

FIG. 7 is a block diagram of an apparatus according to an example embodiment; and

FIG. 8 is a flowchart of a method according to an example embodiment.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the invention.

The present disclosure is generally related to methods and apparatuses for capacitive proximity sensing. Generally, a capacitive proximity detector takes advantage of changes in local capacitance of an electrical element (e.g., an electrode or other capacitive sensing means) that are induced by another object being in close proximity. Capacitive sensors may be mutual or self-capacitance types. Mutual capacitance sensors use two separate conductors, one with a driving signal and the other from which the capacitance is sensed. Self-capacitance sensors use one or more sensing conductors that are connected single-ended to sensing circuits. The embodiments described below are self-capacitance type sensors, although the features described herein may be applicable to other types of capacitance proximity detectors.

A self-capacitance sensor may only require a conductive electrode surrounded by a dielectric, e.g., any combination of air, printed circuit board material, or other dielectric means suitable for mounting a sensor. In response to a signal applied to the electrode (e.g., an alternating current square or sine wave), the electrode will generate a surrounding electrical field. The relationship between voltage and current of the signal can be used to determine an inherent capacitance of the electrode and its surrounding dielectric. An object entering into the electrical field will affect the sensed capacitance of the electrode, and this can be used to determine proximity of the object.

In some applications, the proximity sensor measures two states, touch and no touch. In such an application, a threshold change in capacitance is used to register a touch. In other cases, a finer granularity measurement may be desired. Because the amount of capacitance change will vary based on the distance of the object to the electrode, and a measure of this distance can be estimated by examining the magnitude of the capacitance change.

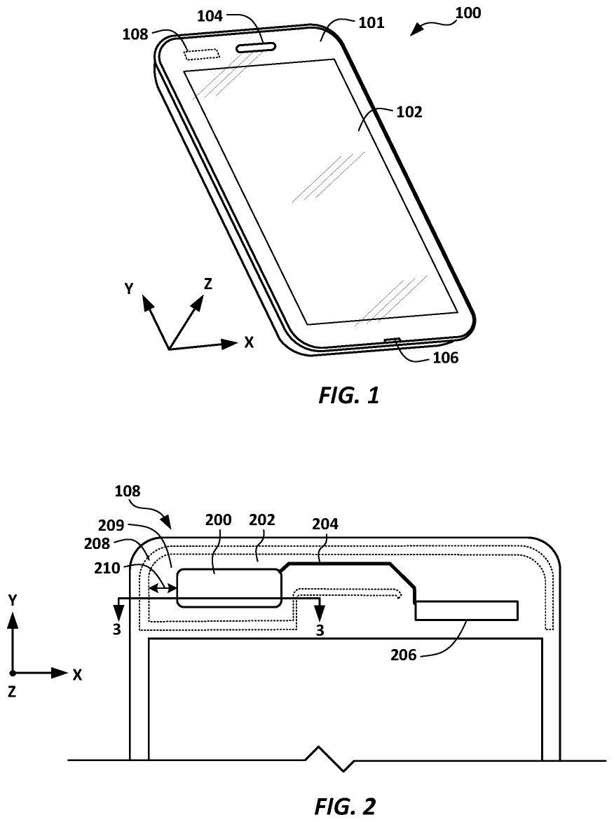

The electrical field generated by the electrode is generally isotropic, e.g., similar in magnitude in all directions surrounding the electrode. As a result, a capacitive sensing electrode will, if isolated on a dielectric, tend to sense objects in all directions. However, in a mobile device proximity sensing application, it may be desirable to limit proximity sensing to particular regions. For example, in FIG. 1, a perspective view of a mobile apparatus 100 illustrates features of a capacitive proximity sensor according to an example embodiment. The apparatus 100 includes a front cover 101 that may include a glass or plastic protective cover. The front cover 101 is at least in part transparent to facilitate viewing of a touchscreen 102.

The touchscreen 102 is proximate to (or integrated with) the front cover 101. The touchscreen 102 may include, among other things, a display, touch sensing grid, and protective layer. The illustrated cover 101 and touchscreen 102 are generally planar on an x-y plane of the illustrated coordinate system, although the front cover 101 and/or touchscreen 102 could have a curved major surface (e.g., the surface or surfaces that comprise a majority of the surface area of the touchscreen 102). At least part of the touchscreen 102 may be formed together with the front cover 101. For example, the front cover 101 may be a substrate on which a touch sensing grid is deposited in a rectangular touch window area that is defined in FIG. 1 by a perimeter of the touchscreen 102.

Located proximate the touchscreen 102 on a front face of the apparatus 100 are a speaker 104 and microphone 106. These devices 104, 106 are used, among other things, for supporting telephone conversations on the apparatus 100. When talking, the users may hold the apparatus 100 close to their faces in order to talk into the microphone 106 and listen from the speaker 104. As a result, the apparatus 100 includes a proximity sensor 108 to detect this and other proximity events, and to take appropriate action, e.g., disable the touchscreen 102 to prevent inadvertent actuation of touchscreen controls.

The proximity sensor 108 is configured to sense proximity events occur at or near a front surface defined by the touchscreen 102. However, it may not be desired for the proximity sensor 108 to detect proximity events elsewhere, e.g., on a side or top edge of the apparatus 100. If the sensor detected proximity at those locations, it may inadvertently take an action (e.g., turning off the touchscreen) that are not intended by the user or desired by the user. Accordingly, various proximity sensor embodiments are described that limit the sensitivity in at least one predefined direction.

In various embodiment, at least part of the proximity sensor 108 may be formed on the front cover 101 in the same process used to deposit the sensing grid of the touchscreen 102, e.g., layer deposition. The proximity sensor 108 is deposited in a region outside the rectangular touch window area of the touchscreen 102. In this location, the proximity sensor 108 is able to detect proximity events in a region of interest (e.g., the user's face being in proximity to the front cover 101), yet has features that prevent false detection of such events outside the region of interest. For example, the proximity sensor 108 may be in a logo region of the front cover 101, e.g., centered at the top or bottom. In such a case, the logo could be formed from a non-transparent magnetic material that is on and/or visible through the cover 101. The logo sensor could be deposited or bonded to an inner surface of the front cover 101 and coupled to sensing circuitry via similar structures/materials used to couple a touchscreen sensor grid to sensing circuitry.

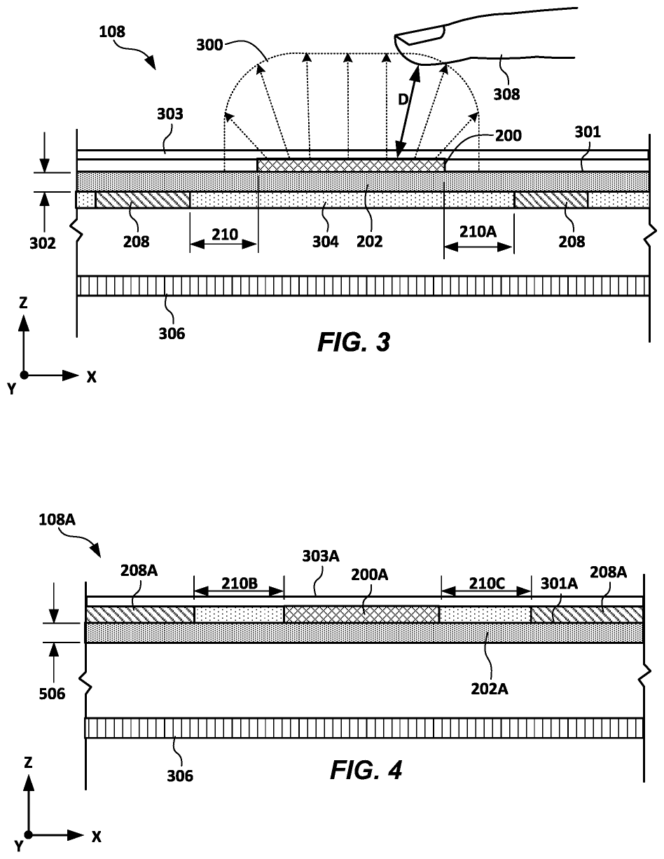

An example embodiment of proximity sensor 108 is shown in the plan view of FIG. 2. The view in FIG. 2 is taken on the x-y plane as shown in FIG. 1, and may include an x-y cross section of any component of apparatus 100. For example, the view of FIG. 2 may represent an inner surface of a touchscreen window (see touch window 300 in FIG. 3). In another example, one or more components may be molded into a substructure frame that holds the touchscreen window (e.g., A-cover) of the apparatus 100. In another embodiment, the view of FIG. 2 may represent an outer surface or cross-section of a printed circuit board (PCB) or flexible printed circuit (FPC) that is located just beneath the front cover of the device.

The capacitive proximity sensor 108 includes a capacitive sensing electrode 200 proximate a first major surface of a dielectric layer 202. The terms “first,” “second,” etc., as used herein to describe surfaces (or other features) are used for convenience to indicate a particular surface (or other feature), and are not intended to indicate orientation, priority, or otherwise limit the meaning of the features beyond what is shown and described herein. The dielectric layer 202 may include a PCB, FPC, A-cover material (e.g., plastic enclosure material), glass or ceramic touchscreen cover, etc. The electrode 200 is disposed on an outer surface of the dielectric layer 202 or may be proximate the outer surface, e.g., embedded within one or more dielectric layers 202. A conductive trace 204 couples the electrode 200 to a connector block 206, which carries signals between the electrode 200 and processing circuitry (not shown).

A conductive layer 208 is also proximate the first major surface of the dielectric layer 202. The conductive layer 208 may be on the same surface and/or coplanar with the electrode 200, or may be disposed on another, parallel surface (e.g., an opposing second surface of the dielectric 202. The conductive layer 208 at least partially surrounds the capacitive sensing electrode 200 and is coupled to a predetermined electrical potential, e.g., a ground potential. For example, the conductive layer 208 may be part of a ground plane coupled to the dielectric layer 202 and/or associated structures (e.g., PCB, FPC, A-cover). In such a case, the ground plane is formed to include a void 209 directly below the electrode that is greater in size than the electrode 200. Although it is expected that the conductive layer 208 will be set to ground potential whether or not it is part of a ground plant, it will be appreciated that similar functionality may be obtained by setting the conductive layer 208 to a non-ground potential.

The electrical fields emitted from the electrode 200 will be limited/inhibited near the conductive layer 208. As such, the conductive layer 208 limits a sensing region of the capacitive sensing electrode 200. For example, in the embodiment shown in FIG. 2, the conductive layer 208 limits sensitivity in regions above, below, and to the left of the electrode. As such, this will limit false indications from the capacitive proximity sensor 108 when the user handles the apparatus by the edges, or when the user is interacting with the touchscreen.

The electrical potential of the conductive layer 208 may be set to a predetermined value, one which is generally held constant. For example, the conductive layer 208 may be coupled to a direct-current potential (e.g., 0 volts). This generally implies that potential may be subject to noise but is not purposefully modulated. This is in contrast to a “driven shield,” which refers to a conductor surrounding an electrode that is driven to create an electrical field having the same polarity as the electrode signal, thereby cancelling out the electrical field in that region. The present embodiment can achieve tailoring of the sensing areas without requiring the circuitry and/or circuit board features associated with a driven shield. For example, because space may be highly confined in a mobile device, there is advantage in the conductive layer 208 performing a dual purpose, e.g., ground plane and sensor range limiter/shaper. As described elsewhere herein, the electrode 200 may also serve a dual purpose, e.g., serving as a logo on or visible through a front cover.

So as not to overly limit overall sensitivity of the sensor 108, there is a gap 210 between edges of the conductive layer 208 and electrode 200. The gap 210 is formed due to a void 209 in the layer 208 having a perimeter larger than the electrode 200. The size of the gap 210 may vary somewhat based on location, the desired tuning of sensor performance, and available space. In one tested prototype, the electrode 200 measured 13 mm wide (x-direction) and 5 mm high (y-direction), and the conductive layer 208 was a 1 mm wide ground layer trace. The spacing 210 in the indicated, left-hand-side region was about 3 mm, and spacing elsewhere between the electrode 200 and conductive layer trace 208 varied between about 1 mm and 2 mm. This was found to detect proximity within a distance of about 9 mm to about 12 mm, the distance being measured normal to the plane of the electrode 200 (the z-direction in FIG. 2).

In reference now to FIG. 3, a block diagram illustrates an example cross sectional view of the capacitive proximity sensor 108 taken along section line 3-3 in FIG. 2. It should be noted that the objects in FIG. 3 are not drawn to scale. Electrical field 300 is generated from the electrode 200, and the field is attenuated in a direction parallel to the major surface 301 of the dielectric layer 202 (the x-direction in this view) by the presence of the conductive layer 208 on either side.

As noted previously, the edge-to-edge gap distance 210 (as well as second gap distance 210A shown in this view) between the conductive layer traces 208 and electrode 200 is selected to tune the amount of attenuation. A thickness 302 of the dielectric layer 202 may also be selected to tune the attenuation. The apparatus may also include a front cover 303, e.g., a touch window lens and/or protective cover, over the sensor 108. The front cover 303 may also affect attenuation of the sensor 108. In one embodiment, the electrode 200 may be deposited on the front cover 303 using the same or similar processes used to deposit a touchscreen sensor grid on the front cover 303.

In this example, a region 304 between portions of the conductive layer trace 208 and directly below the electrode 200 is filled with a non-conductive, dielectric material. This prevents over-attenuation of the sensor 108 in the direction normal to the major surface 301 (positive z-direction). The region 304 may also include some amount of conductive material, e.g., a hatched pattern, that does not substantially limit the strength of the field 300 in the indicated direction. It may be desired to limit sensitivity of the sensor 108 in a direction facing away from the major surface 301 (negative z-direction). In this example, a circuit board 306 may provide attenuation in this direction. Other components, such as a flex cable, conductive rear cover, or other shielding means, may provide a similar function.

The detected capacitance C of the sensor 108 generally increases with: a) increasing dielectric constant E of the touchscreen window 303; b) increasing electrode area A (xy-plane area in these examples); and c) decreasing distance D between an object (e.g., finger 308) and the face of the electrode 200. This may be expressed as C∝E*A/D. The sensing distance D may be generally affected by design parameters according to the relation D∝e1*e2*A*d/(W*C), where e1 and e2 are the respective dielectric constants of the touch window 303 and air between the touch window 303 and object 308, A is area of the electrode 200, d is the gap between the electrode 200 and conductive region 208 (e.g., average of distances 210, 210A), W is the width (x-dimension) of the conductive layer trace 208, and C is the threshold of the detected capacitance.

While not included in the above relationships, the thickness 302 of the dielectric layer 202 may also affect sensing distance D. For example, an increase in the dielectric layer thickness 302 will tend to decrease the attenuation caused by the conductive layer traces 208 because the increase in thickness 302 places the conductive layer traces 208 further away from the electrode 200. However, as shown in FIG. 4, an alternate embodiment of a sensor 108A, the sensing electrode 200A and conductive trace layer 208A may be placed on the same major surface of a dielectric layer 202A.

For the arrangement shown in FIG. 4 to have sensitivity equivalent to the arrangement shown in FIG. 3, spacing 210B, 210C between the electrode 200A and conductive traces 208A may be made larger than spacing 210, 210A. There may be some advantages in placing the sensing electrode 200A and conductive trace layer 208A on the same surface of the dielectric layer 202A. For example, such an arrangement may be easier to manufacture (e.g., reduced number of layers) and have a thinner structure. As with the embodiment of FIG. 3, a front cover 303A may be included in the arrangement of FIG. 4. The electrode 200A and/or the conductive traces 208A may be deposited on the front cover 303A using the same or similar processes used to deposit a touchscreen sensor grid on the front cover 303A. In such a case, the front cover 303A may serve as a dielectric layer in place of or in addition to dielectric layer 202A. A device circuit board 306 or other component may limit sensitivity in a direction opposite the surface 301A of the dielectric layer 202A.

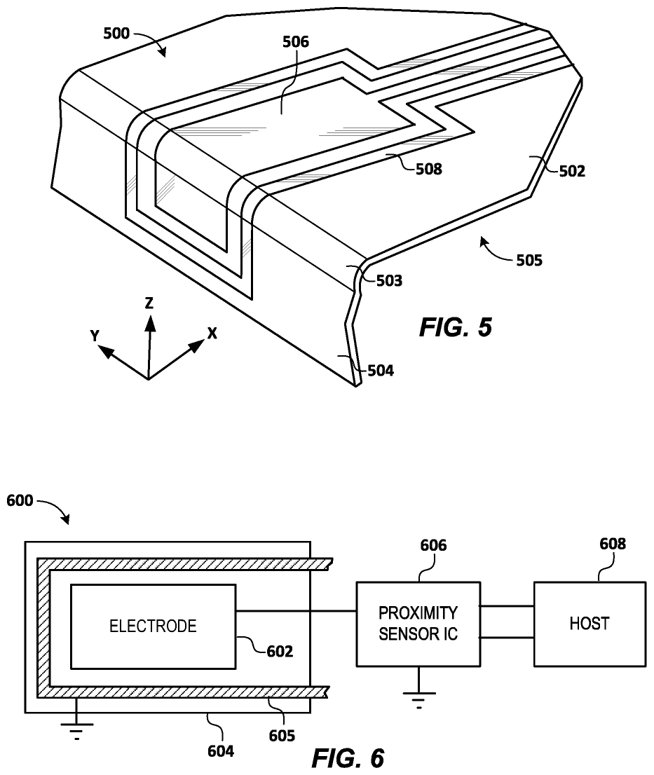

While the illustrated embodiments are shown on planar structures such as PCBs, it will be understood a capacitive proximity sensor as described above may be implemented on a non-planar structure. In reference now to FIG. 5, a perspective view shows a multi-surface capacitive proximity sensor 500 according to an example embodiment. The proximity sensor 500 extends over at least two non-coplanar surfaces 502-504 of a structure 505, where surface 503 is an outer radius corner that joins perpendicular surfaces 502 and 504. The structure 505 may be a front cover, logo region, an inner support structure, outer case, shaped circuit board, flex cable, etc.

The proximity sensor 500 includes an electrode 506 disposed across all three surfaces 502-504 of the structure 505. The electrode 506 is surrounded by a conductive layer trace 508, which also extends across surfaces 502-504. The conductive layer trace 508 limits sensitivity of the proximity sensor 500 in both positive and negative y-directions on all surfaces 502-504. On surface 502, the conductive layer trace 508 limits sensitivity in the positive x-direction, and on surface 504 limits sensitivity in the negative z-direction.

The structure 505 may be multi-layered and may include a dielectric/insulating material on which the electrode 506 and conductive layer trace 508 are disposed. The electrode 506 and conductive layer trace 508 may be on the same surfaces 502-504. Alternatively, one of them may be layered on parallel sub-surface below the other one. For example, the conductive layer trace 508 may be part of a ground plane on disposed underneath outer surfaces 502-504. In another variation, one or both of the electrode 506 and conductive layer trace 508 may be disposed on inner surfaces of the structure 505 instead of the illustrated outer surfaces 502-504. The electrode 506 and conductive layer trace 508 may be molded into the structure 505 similar to processes used for antennas and FPCs. In other variations, the electrode 506 and conductive layer trace 508 may be formed using known PCB etching processes.

In reference now to FIG. 6, a block diagram shows a circuit arrangement using a capacitive proximity sensor 600 according to an example embodiment. The capacitive proximity sensor 600 includes an electrode 602. The electrode 602 is mounted on a non-conductive, dielectric member 604, such as a glass/plastic front cover, circuit board or flex cable. Surrounding the electrode 602 is a conductive trace 605 coupled to ground. The conductive trace 605 may be part of a ground plane, e.g., a signal return path that may also act as a shielding layer of a circuit board. The electrode 602 and conductive trace 605 may have physical configurations illustrated elsewhere herein, e.g., sensor 108 shown in FIGS. 1-3, sensor 108A in FIG. 4, and sensor 500 in FIG. 5.

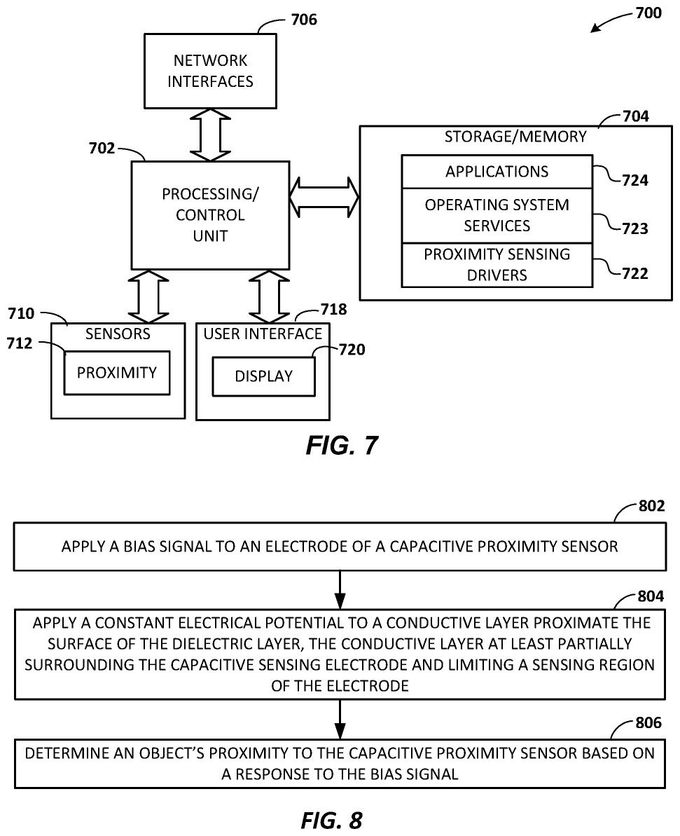

The electrode 602 is coupled to a proximity sensor integrated circuit (IC) 606 that processes signals detected by the sensor 600. The IC 606 may include biasing circuits that apply an AC signal to the electrode 602 and that detect bias signal current flow changes caused by changes in capacitance across the sensor 600. The IC 606 may also include signal conditioning circuits such as filters, amplifiers, buffers, etc., that operate on the analog signals detected from the sensor 600. The IC 606 may also include digital circuitry such as an analog to digital converter (ADC) that converts the analog signal to discrete digital values. The digital circuitry may also include communications circuitry that communicates digital values to a host 608. The host 608 may include a mobile processing device (such as apparatus 700 in FIG. 7) that utilizes the sensor 600 for purposes such as face/cover/pocket detection.

Generally, any of the sensors 108, 108A, 500, 600 described herein may include an electrode formed of indium tin oxide (ITO), copper, or any other conductive material. The conductive layer trace may be formed of copper or other suitable conducting material. The conductive layer and electrode may be formed on any suitable structure, such as a glass or plastic front cover, epoxy PCB, A-cover, glass or plastic rear cover, frame structure, flex cable, flex PCB, etc. A gap between the electrode and conductive trace can facilitate limiting sensitivity of the sensor in a direction along the surface on which the electrode is disposed, without significantly reducing sensitivity in a direction normal to that surface.

In reference now to FIG. 7, a block diagram illustrates an apparatus that includes a proximity sensor according to an example embodiment. The apparatus 700 of FIG. 7 is a representative example of a mobile device, although it will be understood that similar features may be implemented in a variety of mobile and non-mobile devices. The apparatus 700 may include, for example, a mobile apparatus, mobile phone, mobile communication device, mobile computer, laptop computer, desktop computer, server, phone device, video phone, conference phone, television apparatus, digital video recorder (DVR), set-top box (STB), radio apparatus, audio/video player, game device, positioning device, digital camera/camcorder, and/or the like, or any combination thereof. As described in greater detail below, the user apparatus 700 may further include proximity sensing capabilities that facilitate automating some tasks.

The processing unit 702 controls the basic functions of the apparatus 700. Those functions may be configured as instructions (e.g., software, firmware) stored in a program storage/memory 704. The instructions may be provided via computer program product, computer-readable medium, and/or be transmitted to the mobile apparatus 700 via data signals (e.g., downloaded electronically via one or more networks, such as the Internet and intermediate wireless networks). In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer

The mobile apparatus 700 may include hardware and software components coupled to the processing/control unit 702. The mobile apparatus 700 includes one or more network interfaces 706 for maintaining any combination of wired or wireless data connections. These network interfaces 706 enable the apparatus 700 to directly communicate with other devices, and/or join in one or more communication networks.

The mobile apparatus 700 also includes sensors 710 coupled to the processing/control unit 702. These sensors 710 at least include a capacitive proximity sensor 712 as described elsewhere herein. The proximity sensor 712 includes at least an electrode and a conductive trace (e.g., ground line or plane) that selectably limits sensitivity of the proximity sensor 712. The electrode is separated from the conductive trace by a dielectric material, e.g., a structural layer of dielectric material. The proximity sensor 712 may include other components such as connectors, filtering components, etc. These and other sensing devices are coupled to the processor 702 as is known in the art.

The processor 702 is also coupled to user-interface hardware 718 associated with the apparatus. The user-interface 718 may include a display 720, such as a light-emitting diode (LED) and/or liquid crystal display (LCD) device. The user-interface hardware 718 also may include an input device capable of receiving user inputs. This may be integrated with the display 420 (e.g., touchscreen) and/or include dedicated hardware switches. These and other user-interface components are coupled to the processor 702 as is known in the art.

The program storage/memory 704 includes operating systems for carrying out functions and applications associated with functions on the mobile apparatus 700. The program storage 704 may include one or more of read-only memory (ROM), flash ROM, programmable and/or erasable ROM, random access memory (RAM), subscriber interface module (SIM), wireless interface module (WIM), smart card, hard drive, computer program product, and removable memory device. The storage/memory 704 may also include interface modules such as operating system drivers, middleware, hardware abstraction layers, protocol stacks, and other software that facilitates accessing hardware such as user interface 718, sensors 710, and network hardware 706.

The storage/memory 704 of the mobile apparatus 700 may also include specialized software modules for performing functions according to example embodiments discussed above. For example, the program storage/memory 704 includes a driver 722 that provides the OS access to the proximity sensor 712. The operating system may include a service layer 723 that provides applications 724 simplified access to sensor data.

Applications 724 may utilize the service layer 723 to access the sensor 712, or may access the sensor 712 directly via drivers 722 depending on policies of the operating system. An application 724 may use sensed proximity to control various aspects of the apparatus 700. For example, an application 724 may sense that a user's face is close to the apparatus 700 while a phone conversation is in progress, and in response, disable touchscreen operations of the display 720.

In reference now to FIG. 8, a flowchart illustrates a method according to an example embodiment of the invention. The method involves applying 802 a bias signal to an electrode of a capacitive proximity sensor. The electrode is disposed on surface of a dielectric layer (e.g., front cover, PCB, flex cable). A constant electrical potential is applied 804 to a conductive layer proximate the surface of the dielectric layer. The conductive layer at least partially surrounds the capacitive sensing electrode and limits a sensing region of the electrode. An object's proximity to the capacitive proximity sensor is determined 806 based on a response to the bias signal.

The foregoing description of the example embodiments has been presented for the purposes of illustration and description. It is not intended to be exhaustive or to limit the embodiments to the precise form disclosed. Many modifications and variations are possible in light of the above teaching. It is intended that the scope be limited not with this detailed description, but rather determined by the claims appended hereto.

What is claimed is:

1. An apparatus, comprising:
a dielectric layer;
a capacitive sensing electrode disposed on a surface of the dielectric layer, wherein the capacitive sensing electrode is associated with a sensing region; and
a conductive layer disposed on the surface of the dielectric layer, wherein the conductive layer at least partially surrounds the capacitive sensing electrode and is associated with an electrical potential creating a conductive layer potential, wherein the conductive layer is configured to limit a sensing region of the capacitive sensing electrode based on at least the conductive layer potential,
wherein a gap is defined between an edge of the conductive layer that at least partially surrounds the capacitive sensing electrode and an edge of the capacitive sensing electrode, wherein the gap exposes the dielectric layer, and
wherein a distance of the gap is associated with limiting the sensing region of the capacitive sensing electrode in conjunction with at least the conductive layer potential.

2. The apparatus of claim 1, wherein the conductive layer is associated with a non-ground potential.

3. The apparatus of claim 1, wherein the conductive layer limits the sensing region of the capacitive sensing electrode in a direction substantially non-coplanar to the capacitive sensing electrode.

4. The apparatus of claim 1, wherein the conductive layer limits the sensing region of the capacitive sensing electrode in a direction substantially co-planar to the capacitive sensing electrode.

5. The apparatus of claim 1, wherein the capacitive sensing electrode is disposed on a non-coplanar surface.

6. The apparatus of claim 5, wherein the non-coplanar surface comprises a corner joining at least two surfaces substantially perpendicular to each other.

7. The apparatus of claim 5, wherein the non-coplanar surface is disposed on a side of a mobile device.

8. The apparatus of claim 1, wherein the capacitive sensing electrode comprises a logo deposited on or visible through a transparent front cover of the apparatus.

9. The apparatus of claim 1, wherein at least one of the capacitive sensing electrode or the conductive layer are molded together with the dielectric layer.

10. The apparatus of claim 9, wherein said dielectric layer comprises a printed circuit board (PCB) or flexible printed circuit (FPC) or a front cover.

11. A method, comprising:
applying a bias signal to an electrode of a capacitive sensor;
applying an electrical potential to a conductive layer, the conductive layer at least partially surrounding the electrode;
limiting a sensing region of the electrode based on a distance of a gap between edges of the conductive layer and the electrode which exposes a dielectric layer between the electrode and the conductive layer, wherein the gap is defined between an edge of the conductive layer that at least partially surrounds the capacitive sensor electrode and an edge of the capacitive sensor electrode; and
determining an object's proximity to the capacitive sensor based on a response to the bias signal.

12. The method of claim 11, wherein applying an electrical potential to the conductive layer comprises applying a non-ground electrical potential to the conductive layer.

13. The method of claim 11, wherein limiting the sensing region of the electrode comprises limiting the sensing region of the electrode in a direction substantially non-coplanar to the electrode.

14. The method of claim 11, wherein limiting the sensing region of the electrode comprises limiting the sensing region of the electrode in a direction substantially co-planar to the electrode.

15. The method of claim 11, wherein the capacitive sensor electrode is disposed on a non-coplanar surface.

16. The method of claim 15, wherein the non-coplanar surface comprises a corner joining at least two surfaces substantially perpendicular to each other.

17. The method of claim 15, wherein the non-coplanar surface is disposed on a side of a mobile device.

18. The method of claim 11, wherein the electrode comprises a logo deposited on or visible through a transparent front cover.

19. The method of claim 11, wherein at least one of the capacitive sensor electrode or the conductive layer are molded together with the dielectric layer.

20. The method of claim 11, further comprising limiting the sensing region of the electrode dynamically based on a condition requiring adjustment of the sensing region.
